(19) United States
(12) Patent Application Publication
(10) Pub. No.: US 2002/0071705 A1
(43) Pub. Date: Jun. 13, 2002

(54) Keyboard with illuminated keys

(76) Inventors: Ralph Zilberman, Staten Island, NY (US); Sergey Yefremov, Brooklyn, NY (US)

Correspondence Address: Richard W. Goldstein, 2071 Clove Road, Staten Island, NY, 10304, US

(21) Appl. No.: 09/735,046

(22) Filed: Dec. 13, 2000

(51) Int. Cl. B41J 5/14

(52) U.S. Cl. 400/472; 400/477

(57) ABSTRACT

A keyboard with illuminated keys including a keyboard housing having a plurality of key recesses formed therein. A plurality of keys are received within the plurality of key recesses of the keyboard housing. The plurality of keys each have a generally square configuration. The keys each have an upper end and a lower end. The lower end has a pair of recesses formed therein. The recesses each have a light disposed therein. The upper end is divided into two sections. The two sections each correspond with one of the lights of the pair of recesses. Each of the two sections have illuminatable indicia disposed thereon. The plurality of keys include at least one shift key. The shift key controls the activation of the lights whereby a pressing of the shift key causes one of the lights to illuminate and a release of the shift key causes the other light to illuminate thereby illuminating the indicia of one of the sections at one time.

### BACKGROUND OF THE INVENTION

The present invention relates to a keyboard with illuminated keys and more particularly pertains to utilizing light sources to illuminate the keys as either lower case or upper case letters.

Many computer users are working at their computers until all hours. Sometimes, these people are confronted with the problem of properly visualizing their keyboard. This often results in typographical errors. What is needed is a way for computer users to easily view the keys of the keyboard in order to avoid making mistakes.

The present invention attempts to solve the abovementioned problem by providing a keyboard that illuminates the keys whereby the keys are provided with both upper and lower case letters so that the proper case is illuminated for the person inputting data.

The use of keyboard illumination devices is known in the prior art. More specifically, keyboard illumination devices heretofore devised and utilized for the purpose of illuminating keyboards are known to consist basically of familiar, expected and obvious structural configurations, notwithstanding the myriad of designs encompassed by the crowded prior art which have been developed for the fulfillment of countless objectives and requirements.

By way of example, U.S. Pat. No. 4,670,633 to Kaiwa discloses a keyboard with a means for illuminating push buttons using a small number of light sources. U.S. Pat. No. 4,163,883 to Boulanger and U.S. Pat. No. 4,288,672 to Puccini disclose various means for illuminating a keyboard used with a control panel.

While these devices fulfill their respective, particular objective and requirements, the aforementioned patents do not describe a keyboard with illuminated keys for utilizing light sources to illuminate the keys as either lower case or upper case letters.

In this respect, the keyboard with illuminated keys according to the present invention substantially departs from the conventional concepts and designs of the prior art, and in doing so provides an apparatus primarily developed for the purpose of utilizing light sources to illuminate the keys as either lower case or upper case letters.

Therefore, it can be appreciated that there exists a continuing need for a new and improved keyboard with illuminated keys which can be used for utilizing light sources to illuminate the keys as either lower case or upper case letters. In this regard, the present invention substantially fulfills this need.

### SUMMARY OF THE INVENTION

In the view of the foregoing disadvantages inherent in the known types of keyboard illumination devices now present in the prior art, the present invention provides an improved keyboard with illuminated keys. As such, the general purpose of the present invention, which will be described subsequently in greater detail, is to provide a new and improved keyboard with illuminated keys which has all the advantages of the prior art and none of the disadvantages.

To attain this, the present invention essentially comprises a keyboard housing having a plurality of key recesses formed therein. A plurality of keys are received within the plurality of key recesses of the keyboard housing. The plurality of keys each have a generally square configuration. The keys each have an upper end and a lower end. The lower end has a pair of recesses formed therein. The recesses each have a light disposed therein. The upper end is divided into two sections. The two sections each correspond with one of the lights of the pair of recesses. Each of the two sections have illuminatable indicia disposed thereon. The plurality of keys include at least one shift key. The shift key controls the activation of the lights whereby a pressing of the shift key causes one of the lights to illuminate and a release of the shift key causes the other light to illuminate thereby illuminating the indicia of one of the sections at one time.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved keyboard with illuminated keys which has all the advantages of the prior art keyboard illumination devices and none of the disadvantages.

It is another object of the present invention to provide a new and improved keyboard with illuminated keys which may be easily and efficiently manufactured and marketed.

It is a further object of the present invention to provide a new and improved keyboard with illuminated keys which is of durable and reliable construction.

An even further object of the present invention is to provide a new and improved keyboard with illuminated keys which is susceptible of a low cost of manufacture with regard to both materials and labor, and which accordingly is then susceptible of low prices of sale to the consuming public, thereby making such a keyboard with illuminated keys economically available to the buying public.

Even still another object of the present invention is to provide a new and improved keyboard with illuminated keys for utilizing light sources to illuminate the keys as either lower case or upper case letters.

Lastly, it is an object of the present invention to provide a new and improved keyboard with illuminated keys including a keyboard housing having a plurality of key recesses formed therein. A plurality of keys are received within the plurality of key recesses of the keyboard housing. The plurality of keys each have a generally square configuration. The keys each have an upper end and a lower end. The lower end has a pair of recesses formed therein. The recesses each have a light disposed therein. The upper end is divided into two sections. The two sections each correspond with one of the lights of the pair of recesses. Each of the two sections have illuminatable indicia disposed thereon. The plurality of keys include at least one shift key. The shift key controls the activation of the lights whereby a pressing of the shift key causes one of the lights to illuminate and a release of the shift key causes the other light to illuminate thereby illuminating the indicia of one of the sections at one time.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a plan view of the preferred embodiment of the keyboard with illuminated keys constructed in accordance with the principles of the present invention.

FIG. 2 is a perspective view of one of the keys of the present invention.

FIG. 3 is a cross-sectional side view of the present invention as taken along line 3-3 of FIG. 1.

The same reference numerals refer to the same parts through the various figures.

### DESCRIPTION OF THE PREFERRED EMBODIMENT

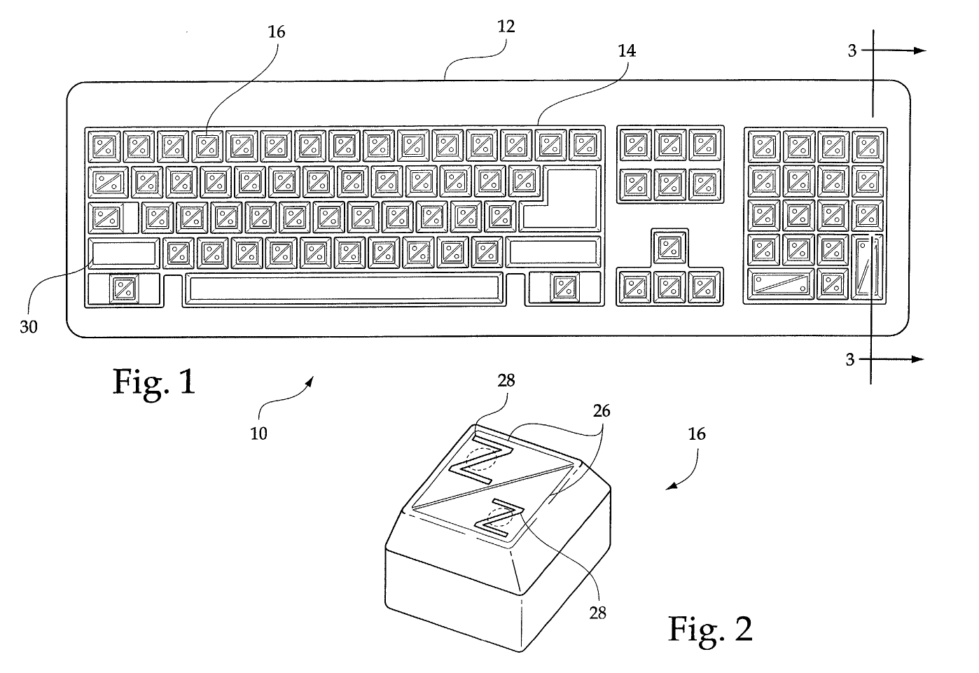

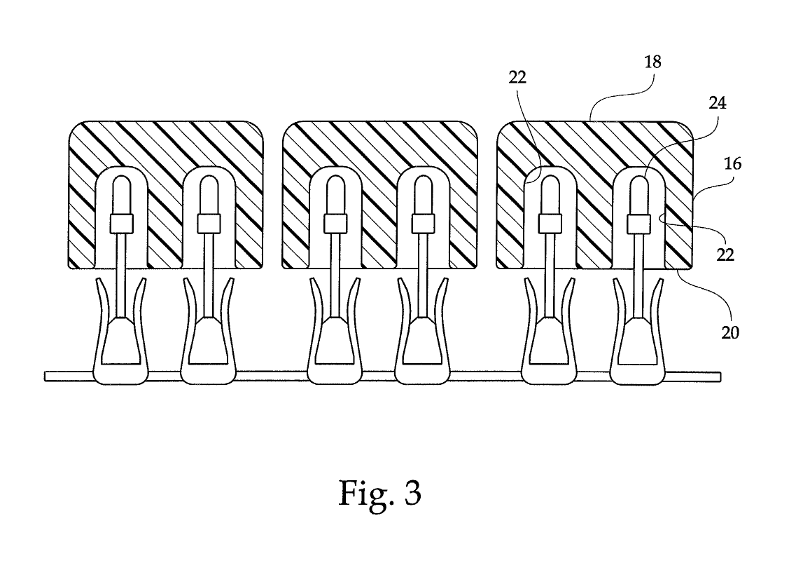

With reference now to the drawings, and in particular, to FIGS. 1 through 3 thereof, the preferred embodiment of the new and improved keyboard with illuminated keys embodying the principles and concepts of the present invention and generally designated by the reference number 10 will be described.

Specifically, it will be noted in the various figures that the device relates to a keyboard with illuminated keys for utilizing light sources to illuminate the keys as either lower case or upper case letters. In its broadest context, the device consists of a keyboard housing and a plurality of keys. Such components are individually configured and correlated with respect to each other so as to attain the desired objective.

The keyboard housing 12 has a plurality of key recesses 14 formed therein. The arrangement of the keyboard housing 12 is similar to keyboards known in the art.

The plurality of keys 16 are received within the plurality of key recesses 14 of the keyboard housing 12. The plurality of keys 16 each have a generally square configuration. The keys 16 each have an upper end 18 and a lower end 20. The lower end 20 has a pair of recesses 22 formed therein. The recesses 22 each have a light 24 disposed therein. The upper end 18 is divided into two sections 26. The two sections 26 each correspond with one of the lights 24 of the pair of recesses 22. Each of the two sections 26 have illuminatable indicia 28 disposed thereon. The indicia 28 on some of the keys 16 are letters. These keys 16 have upper case letters on one section and lower case letters on the other section. Note FIG. 2. Other keys are presented with numbers on one section of the key 16 and a corresponding symbol on the other section of the key 16. The plurality of keys 16 include at least one shift key 30. The shift key 30 controls the activation of the lights 24 whereby a pressing of the shift key 30 causes one of the lights 24 to illuminate and a release of the shift key 30 causes the other light 24 to illuminate thereby illuminating the indicia 28 of one of the sections 26 at one time. Thus, when the user is pressing the shift key 30, the upper case letters on the keys 16 will be illuminated as well as the symbols on the other keys. When the shift key 30 is released, the lower case letters and the numbers will be illuminated.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A keyboard with illuminated keys for utilizing light sources to illuminate the keys as either lower case or upper case letters comprising, in combination:
a keyboard housing having a plurality of key recesses formed therein;
a plurality of keys received within the plurality of key recesses of the keyboard housing, the plurality of keys each having a generally square configuration, the keys each having an upper end and a lower end, the lower end having a pair of recesses formed therein, the recesses each having a light disposed therein, the upper end being divided into two sections, the two sections each corresponding with one of the lights of the pair of recesses, each of the two sections having illuminatable indicia disposed thereon, the plurality of keys including at least one shift key, the shift key controlling the activation of the lights whereby a pressing of the shift key causes one of the lights to illuminate and a release of the shift key causes the other light to illuminate thereby illuminating the indicia of one of the sections at one time.
